(19) United States
(12) Patent Application Publication
(10) Pub. No.: US 2014/0124718 A1
(43) Pub. Date: May 8, 2014

(54) COMPENSATION OF MEASURING ERRORS IN HANDLING EQUIPMENT

(71) Applicant: tecsis GmbH, Offenbach (DE)

(72) Inventors: Hartmut Fürniss, Linkenheim (DE); Drazen Rot, Frankfurt am Main (DE)

(73) Assignee: TECSIS GMBH, Offenbach (DE)

(21) Appl. No.: 14/138,085

(22) Filed: Dec. 22, 2013

Related U.S. Application Data
(63) Continuation of application No. 13/287,538, filed on Nov. 2, 2011.

(30) Foreign Application Priority Data
Nov. 9, 2010 (DE) 202010015180.5

(51) Int. Cl. B66C 13/04; B66C 19/00; G01L 25/00

(52) U.S. Cl. CPC B66C 13/04; G01L 25/00; B66C 19/007
USPC 254/280; 73/1.08; 254/286

(57) ABSTRACT

A method is provided for compensating measuring errors for handling equipment with a drive carrier that includes a carrier part and driven drums for moving the steel cables arranged thereon and including a handling receptacle in which the handling receptacle is suitable for picking up loads and is connected to the carrier part by deflection pulleys via the support cables a id a controllable lever mechanism that is at least connected to at least two support cables and with at least two force sensors that capture the forces of at least two support cables and a monitoring device that monitors the forces of the at least two force sensors. An adjustment angle of the controllable lever mechanism is captured by sensors and a correction of the cable forces based on the captured adjustment angle is carried in the monitoring device.

### BACKGROUND AND SUMMARY

The present application is a continuation of U.S. application Ser. No. 13/287,538, filed, Nov. 2, 2011, and claims priority to DE202010015180.5, filed Nov. 9, 2010.

The invention concerns a method for compensating measuring errors for handling equipment comprising a drive carrier that is comprised of a carrier part and driven drams for moving the steel cables arranged thereon and comprising a handling receptacle in which the handling receptacle is suitable for picking up loads and is connected to the carrier part by means of deflection pulleys via the support cables and comprising a controllable lever mechanism that is connected to at least two support cables and with at least two force sensors that capture the forces of at least two support cables and comprising a monitoring device that monitors the forces of at least two force sensors.

During lifting or setting down, containers can be moved into their required position by means of changes to the cable control via a lever mechanism (ref. FIG. 4) also ref FIG. 3. An angle alpha (α) on the lever causes an angle beta (β) on the container. To this end two cables remain in position. Cable 1 is extended a little and cable 2 is shortened a little. This turning by means of the lever results in a measuring error in sensors S1 and S2 of the cable monitoring system that otherwise monitor the container weight. Faulty values can result to a complete shut-down of the crane due to safety reasons and thus to undesired idle times.

When lifting and setting down containers in a turned position, a lever error can result in a shut-down of the crane due to a faulty measurement.

According to an aspect of the invention an adjustment angle of the controllable lever mechanism is captured by a sensor and in that a correction of the cable forces based on the captured adjustment angle is carried out in the monitoring device.

In order to eliminate the error, the cable forces in two of four cables are monitored, for example, the lever angle is determined with the help of an angle sensor and calculated based on the characteristic lines of the errors.

This allows for a simple and inexpensive compensation of a systematic error when determining the weight of a load attached to the handling equipment by measuring the forces that act on the support cables.

Advantageously, the cable forces are monitored continuously.

In an especially advantageous embodiment of the method according to an aspect of the invention the corrected cable forces are converted to a weight that corresponds to the load that is attached to the handling receptacle. By doing this, it is very easy to determine whether a weight of the attached load is exceeding a maximum weight that the handling equipment can carry.

According to an aspect of the invention the force sensors that are in the form of pins evaluate the forces of the support cables attached in a loop.

Advantageously, the cable forces of the support cables are determined for a zero position of the lever mechanism and for at least two additional different deflections of the lever mechanism in a previous step and then are used for correcting the cable forces in the monitoring device. In doing so, the method according to an aspect of the invention can easily be used in a multitude of different handling equipment since the design-based information required for the compensation for the respective type of handling equipment can easily be determined with a simple experiment.

To this end the characteristic lines are determined beforehand on the end stops of the lever with empty and loaded container using teach-in. The curves that are determined in this manner are saved and evaluated in the control using the actual angle.

The accuracy of the measuring error compensation can further be improved by determining, in a preceding step, the cable forces of the support cables for the zero position of the lever mechanism and for the at least two additional different deflections of the lever mechanism using a defined load on the handling receptacle as well as an empty handling receptacle.

In an especially advantageous embodiment of the method correction functions are generated arithmetically based on the cable forces determined in the preceding step and are saved in the monitoring device with the correction functions allowing for a corrected load calculation for the handling receptacle for each adjustment angle of the lever mechanism.

The data required for compensation can be determined especially inexpensively by controlling the determination of the values for the monitoring device using a control device or a computer that can be connected to the monitoring device. In doing so the functions or components, respectively, required for determining the necessary data do not need to be in the monitoring device but rather can be maintained in a separate control device that can be connected to the monitoring device.

The invention, according to an aspect thereof, also concerns handling equipment with a drive carrier that is comprised of a carrier part and driven drums for moving the steel cables arranged thereon and comprising a handling receptacle in which the handling receptacle is suitable for picking up loads and is connected to the carrier part by means of deflection pulleys via the support cables and comprising a controllable lever mechanism that is connected to at least two support cables and with at least two force sensors that capture the forces of at least two support cables and comprising a monitoring device that monitors the forces of the at least two force sensors.

According to an aspect of the invention the handling equipment comprises a compensation device whereby sensors capture the adjustment angle of the controllable lever mechanism and a correction to the cable forces is made in the monitoring device based on the determined adjustment angle.

Using the captured adjustment angle, a systematic error in determining the weight of a load attached to the handling equipment can easily and inexpensively be compensated by means of the monitoring device.

The compensation of a measuring error can be achieved particularly inexpensively in that the sensors are comprised of angle measuring sensors.

Advantageously the angle measuring sensors are fastened in a fixed manner to an adjustment lever of the lever mechanism. This allows for an especially simple assembly of the angle measuring sensors.

According to an aspect of the invention the force sensors advantageously are fastened to a lever of the lever mechanism for monitoring the support cables.

In an advantageous embodiment of the inventive thought the handling receptacle can be turned relative to the carrier part by adjusting the lever mechanism.

Advantageously at least two support cables are fastened to the lever mechanism on different sides in relation to a pivot point.

According to an aspect of the invention at least two support cables advantageously are fastened to the lever mechanism, each at the same distance in relation to a pivot point.

In order to increase the radius of action of the handling equipment, the handling equipment is arranged on wheels in a mobile and steerable manner.

In order to be able to use the handling equipment for transporting or lifting standardized containers as well, the handling receptacle, in accordance with an aspect of the invention, comprises a four-point fastening system for accommodating a container.

Advantageously, the handling equipment is a component of a container load crane on tracks.

### BRIEF DESCRIPTION OF THE DRAWINGS

FIG. 1 is a schematic end view of a compensation device according to an aspect of the invention;

FIG. 2 is a schematic end view of a compensation device according to an aspect of the invention;

FIG. 3 is a schematic top view of a compensation device according to an aspect of the invention;

FIG. 4 is a schematic view of a portion of a compensation device according to an aspect of the invention;

FIG. 5 is a schematic view of wiring for a compensation device according to an aspect of the invention;

FIG. 6 is a graph of load change versus angle;

FIG. 7 is a graph of saved correction functions;

FIG. 8 is a graph of spreader load versus angle; and

FIGS. 9 and 10 show how software is used to automatically calibrate.

### DETAILED DESCRIPTION

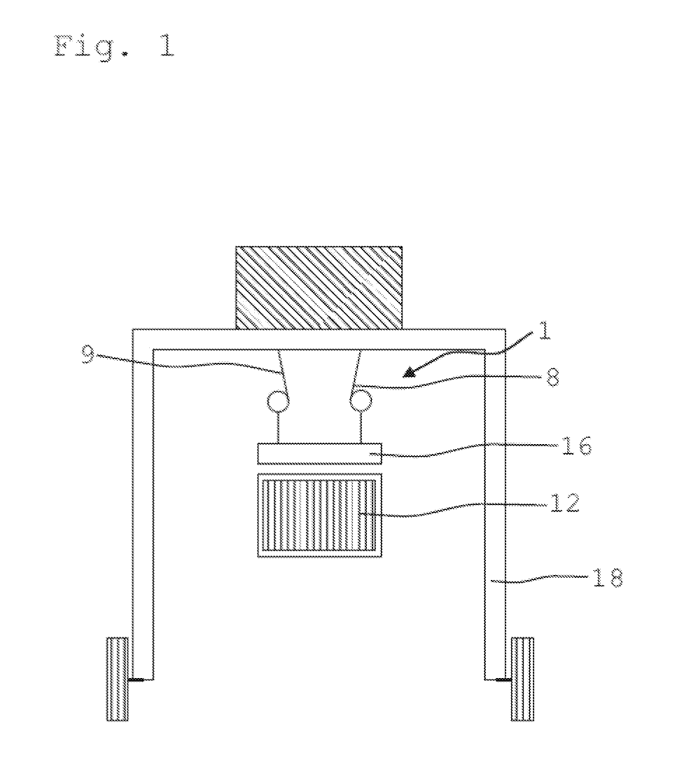

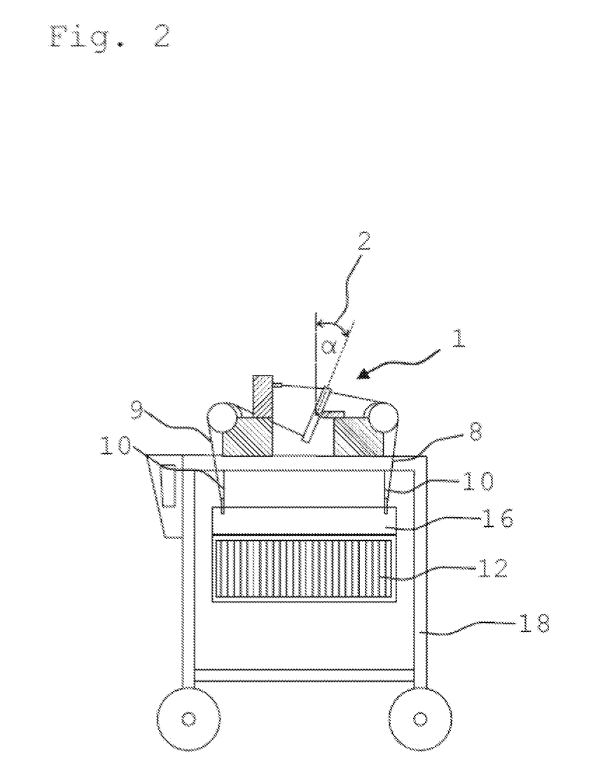

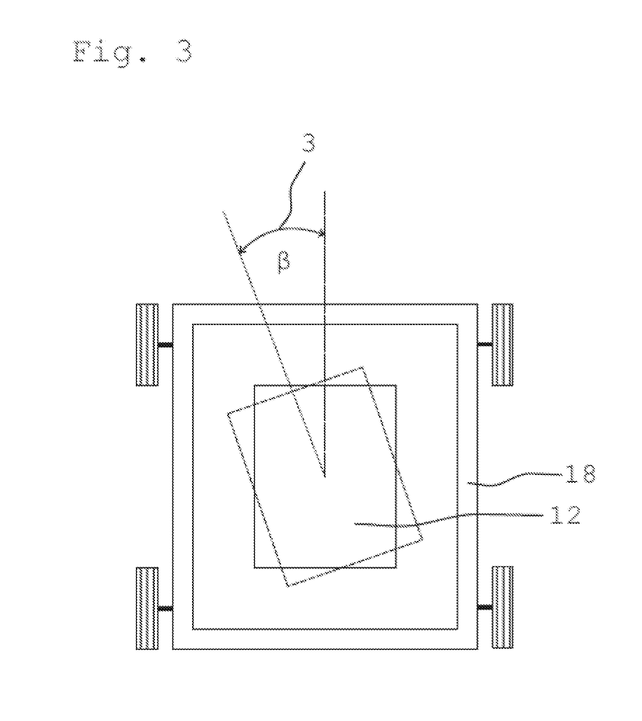

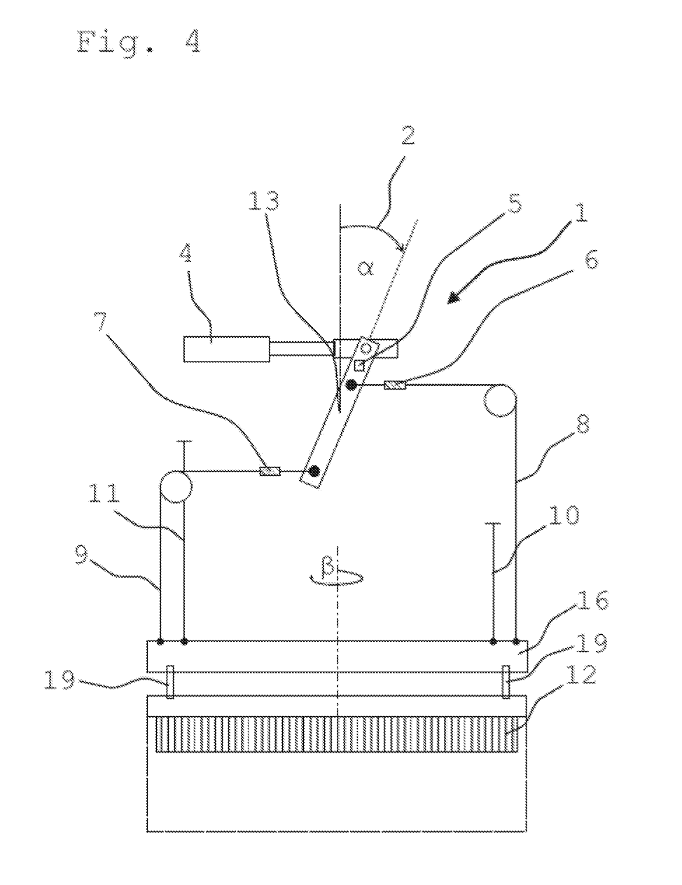

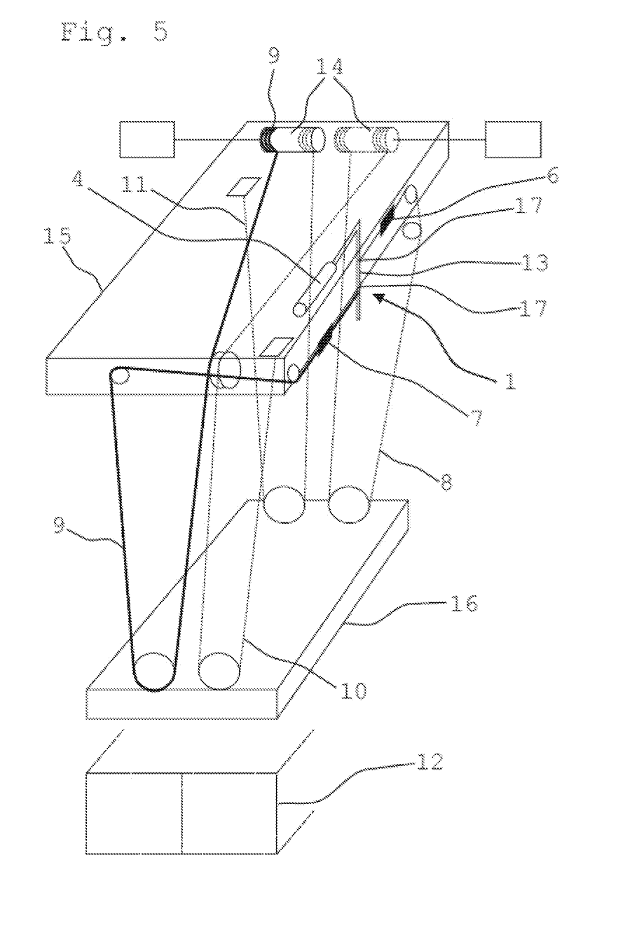

The following paragraphs describe the method for setting up the compensation device for container handling equipment according to the schematic view shown in FIG. 1-5 and FIG. 11.

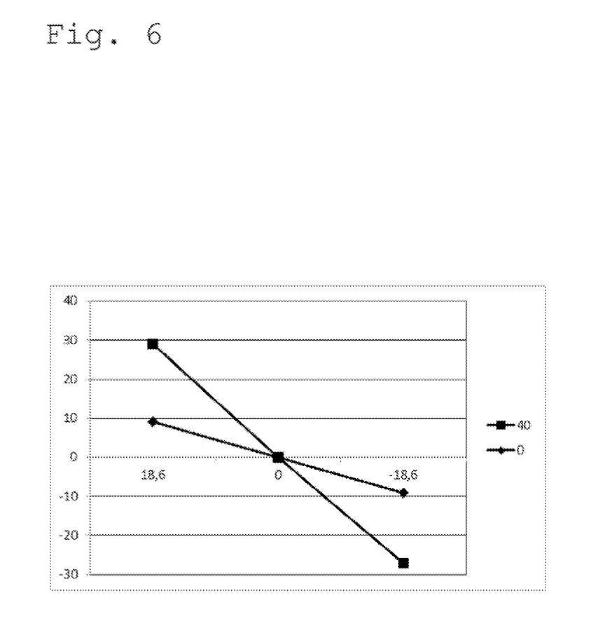

FIG. 5 shows an example of how the cables run.

To ensure that the load values are not affected by the geometry of the crane, an overall calibration is carried out. In doing so, new parameters are obtained while taking the existing geometry into consideration. Based on these parameters, the final load, value can be corrected accordingly.

There may be an additional problem when slewing cranes are used. During the stewing process the cranes can have a linear signal change in the zero point as well as in the end point. These affect the entire angle or slowing range, respectively.

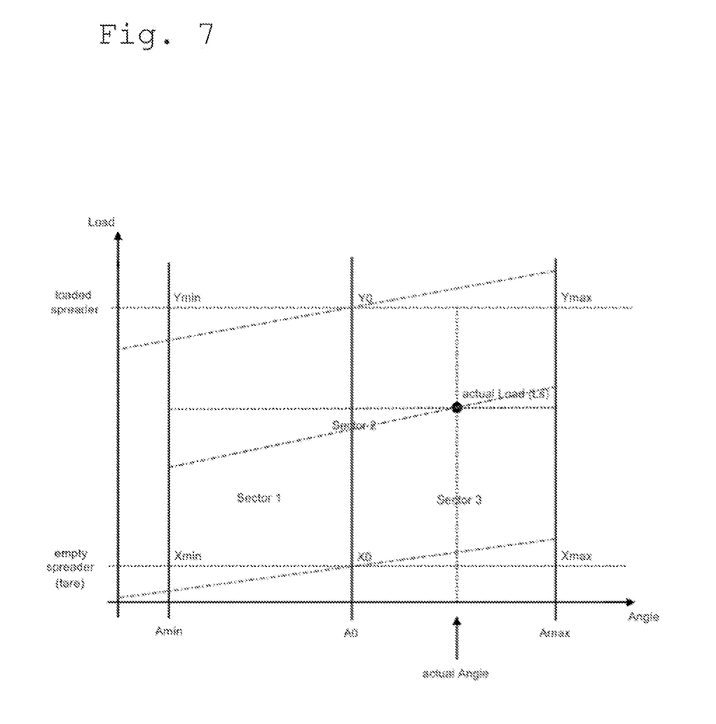

This method is explained in more detail based on the diagram shown in FIG. 6. In the example shown in FIG. 6 the angle was started in a slewing range of 18.6° to −18.6°. In doing so, a load change of 10 t to −10 t or 30 t to approx. −30 t was observed in the zero point and in the end point.

A solution was required that can be operated easily and intuitively. The operator should not need to have any specific knowledge about the geometry of the crane. It should also be possible to determine all parameters automatically so that no calculations are required in advance to set up the parameters for overload protection.

Configuration software is used for setting up the control or monitoring device, respectively.

The calibration routine contained in this software was expanded by an automatic multi-teach-in method. Apart from entering the test weight, all parameters are automatically captured and calculated in this method.

To this end first all inputs for the load measurements are configured. Then a minimum and maximum slew range is configured for the angle transducer. After all inputs are properly configured, the actual calibration takes place.

The following sequence can be carried out in an order [sic].

The crane is placed in the starting position. First, the empty spreader is lifted and the tare weight is determined using an interface. Then a test weight is lifted. To this end the operator enters the load value of the test weight into an input field and activates a calibration interface. During the subsequent calibration process all values (load and angle) are determined automatically and from this the parameters for the characteristic line are saved.

This process is repeated for the two minimum and maximum slew ranges.

During operation an angle transducer is analyzed and the current position of the crane within the slew range is determined. Depending on the position, the respective data record is loaded and used for recalculating the characteristic line in relation to the angle position. The newly calculated characteristic line then is used for correcting the load values.

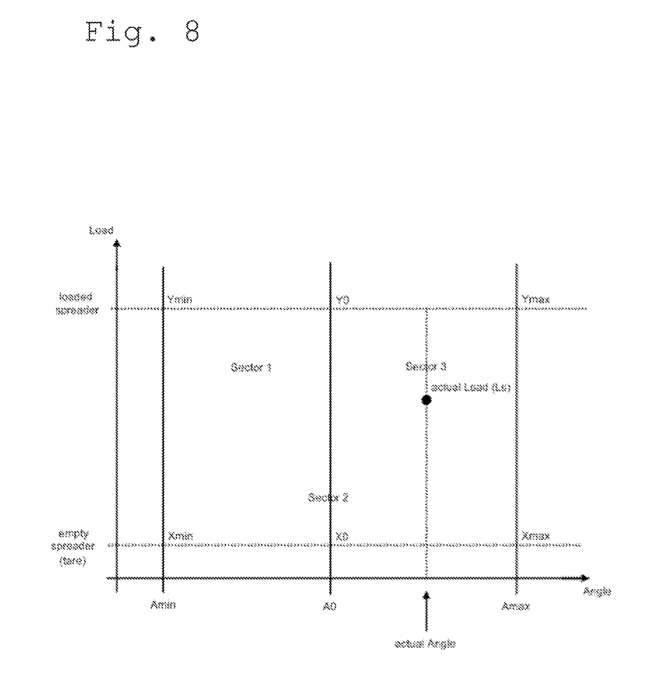

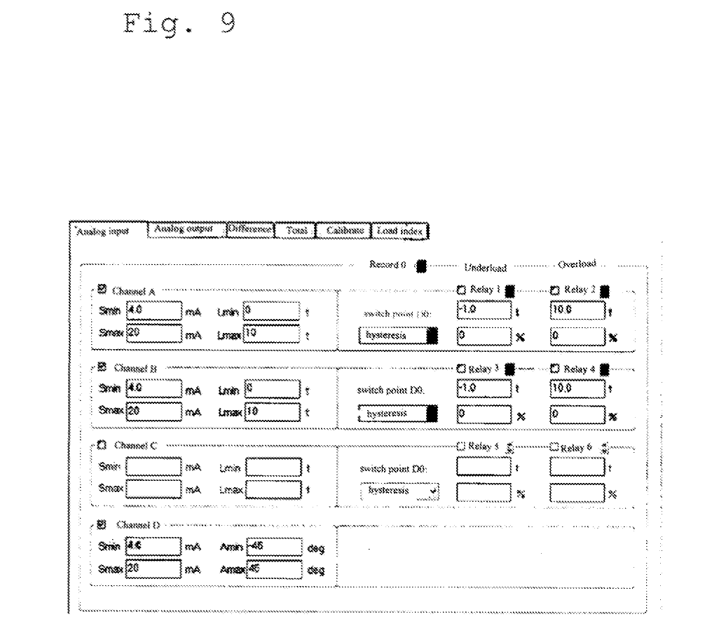

The diagram shown in FIG. 7 shows a presentation of the correction functions that are saved.

The calculation of the load values in relation to the angle position is explained in detail in the following paragraphs.

In order to calculate the individual loads and the angle, first all parameters for minimum and maximum power signals as well as the respective load or angle values are loaded. Based on this, the incline and offset for the load or angle value, respectively, are calculated.

After receiving filtered signal values (ADC values), the individual loads (channels A, B, and C) and the angle (channel D) are calculated.

The result of L1 and L2 are for current individual load values and A1 is for the current angle value.

In order to calculate the sum of the loads in relation to the angle, all parameters that were determined during automatic calibration, are loaded. Then all individual loads are added to one total load. The following parameters that are used for interpolation are derived from values Xmin, X0, Xmax as well as Ymin, Y0 and Ymax: Mmin, M0, Mmax, Bmin, B0, Bmax, taremin. tare0, and taremax.

The following ranges are defined:

Range 1=between angle min and angle 0
Range 2=angle 0
Range 3=between angle 0 and angle max.

Depending on the range in which the current angle value is situated, the respective parameters for incline, offset and tare are used for the calculation.

For the calculation first new values are determined for the incline, offset and tare for the subsequent calculation of the total load:

Incline: M_{—}w=−((Mmax−M0)*(Amax−A1)/(Amax−A0)+Mmax

Offset: B_{—}w=−((Bmax−b0)*(Amax−A1)/(Amax−A0)+Bmax

Tare: Tare_{—}w=−((taremax−tare0)*(Amax−A1)/(Amax−A0)+taremax

Then the current total load is calculated from these values:

Ls=((L1+L2)*M_{—}w+B_{—}w)−tare_{—}w

The calibration parameters for the total load value also are used to correct the individual load values:

L1corr=L1M_{—}w+(B_{—}w/number of signals)−(tare_{—}w/number of signals)

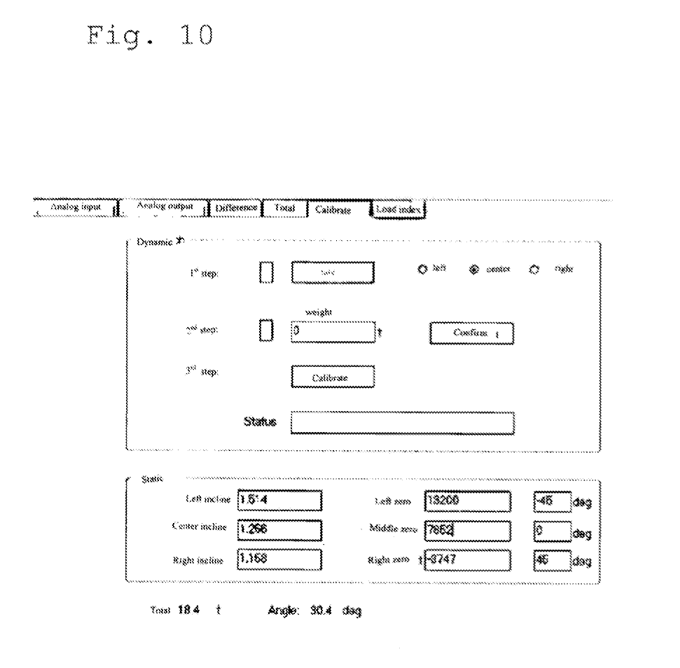

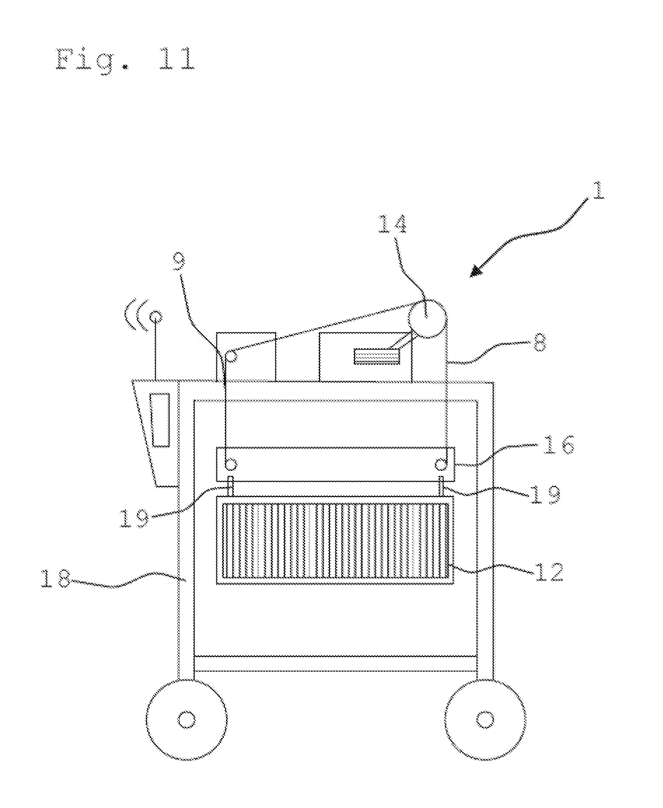

In the following paragraphs the automatic calibration using the PC software is explained based on FIGS. 9 and 10.

First, the analog inputs, for example load signals (A, B, and C) and the angle transducer (D) are configured.

The angle can be entered in a range between −360 to +360 degrees and from 4 to 20 mA.

After the individual input signals are configured, the sums are calibrated (FIG. 10). For the calibration of the sums the crane first is placed in the starting position A0. Then the empty hook (spreader) is lifted and the current dead weight is determined (tare weight). Then a test weight (approx. ¾ of the maximum weight) is attached and the range for A0 is calibrated.

Then the crane is slewed to the mitt angle position (Amin) and the calibration process, as already described for A0, is carried out.

Then the crane is stewed to the opposite position (Amax) and the calibration process is carried out again as described.

The order of the angle positions is random and does not need to be followed.

All measuring values (load and angle) are automatically captured and calculated. The operator only must provide the test weight.

All automatically captured and calculated values can also be set manually before as we as after the calibration.

Based on the calibration, the parameters for incline, offset as well as the tare value for each angle position (Amin, A0 and Amax) are obtained. This means that overall six parameters for further interpolation of the load values are available.

### REFERENCE NUMBER LIST

1 Lever mechanism
2 Angle alpha (α)
3 Angle beta (β)
4 Hydraulic cylinder
5 Angle sensor As
6 Sensor S1=FS1
7 Sensor S2=FS2
8 Cable 1
9 Cable 2
10 Cable 3
11 Cable 4
12 Container
13 Pivot point
14 Drums for the cables
15 Frame
16 Spreader
17 Cable anchor points on lever and three sensors for cable monitoring
18 Vehicle “ATM” for lifting and transporting containers
19 Locking pins

1. Method for compensating measuring errors for handling equipment with a drive carrier that is comprised of a carrier part and driven drums for moving the steel cables arranged thereon and comprising a handling receptacle in which the handling receptacle is suitable for picking up loads and is connected to the carrier pan by means of deflection pulleys via the support cables and a comprising controllable lever mechanism that is at least connected to at least two support cables and with at least two force sensors that capture the forces of at least two support cables and comprising a monitoring device that monitors the forces of the at least two force sensors comprising capturing an adjustment angle of the controllable lever mechanism by sensors and carrying a correction of the cable forces based on the captured adjustment angle in the monitoring device.

2. Method for compensating measuring errors according to claim 1 wherein the cable forces are monitored continuously.

3. Method for compensating measuring errors according, to claim 1 wherein the corrected cable forces are calculated into a weight value that corresponds to a load fastened to the handling receptacle.

4. Method for compensating measuring errors according to claim 1 wherein the force sensors that are in the form of pins evaluate the forces of the support cables attached in a loop.

5. Method for compensating measuring errors according to claim 1 wherein in a preceding step cable threes of the support cables are determined for a zero position of the lever mechanism and for at least two additional different deflections of the lever mechanism that are used for correcting the cable forces in the monitoring device.

6. Method for compensating measuring errors according to claim 5 wherein in the preceding step the cable forces of the support cables for the zero position of the lever mechanism and for the at least two additional different deflections of the lever mechanism are determined with a defined load on the handling receptacle as well as for an empty handling receptacle.

7. Method for compensating measuring errors according, to claim 5 wherein based on the cable forces determined in the preceding step correction functions are generated arithmetically and are saved in the monitoring device with the correction functions allowing for a corrected load calculation for the handling receptacle for each adjustment angle of the lever mechanism.

8. Method for compensating measuring errors according to claim 5 wherein the determination of the values for the monitoring device can be controlled using a control device or a computer that can be connected to the monitoring device.

9. Handling equipment comprising a drive carrier that is comprised of a carrier part and driven drums for moving the steel cables arranged thereon and comprising a handling receptacle in which the handling receptacle is suitable for picking up loads and is connected to the carrier part by means of deflection pulleys via the support cables and comprising a controllable lever mechanism that is connected to at least two support cables and with at least two force sensors that capture the forces of at least two support cables and comprising a monitoring device that monitors the forces of the at least two force sensors wherein handling equipment comprises a compensation device whereby sensors capture the adjustment angle of the controllable lever mechanism and a correction to the cable forces is made in the monitoring device based on the determined adjustment angle.

10. Handling equipment according to claim 9 wherein the sensors are comprised of angle measuring sensors.

11. Handling equipment according to claim 10 wherein the angle measuring sensors are fastened in a fixed manner to an adjustment lever of the lever mechanism.

12. Handling equipment according to claim 9 wherein the force sensors for monitoring the support cables are fastened to a lever of the lever mechanism.

13. Handling equipment according to claim 9 wherein the handling receptacle can be turned relative to the carrier part by adjusting the lever mechanism.

14. Handling equipment according to claim 9 wherein at least two support cables are fastened to the lever mechanism on different sides in relation to a pivot point.

15. Handling equipment according to claim 9 wherein at least two support cables are fastened to the lever mechanism, each at the same distance in relation to a pivot point.

16. Handling equipment according to claim 9 wherein the handling equipment is arranged on wheels in a mobile and steerable manner.

17. Handling equipment according to claim 9 wherein the handling receptacle comprises a four-point fastening system for accommodating a container.

18. Handling equipment according to claim 9 wherein the handling equipment is a component of a container load crane on tracks.
